(19) United States
(12) Patent Application Publication
(10) Pub. No.: US 2019/0265349 A1
(43) Pub. Date: Aug. 29, 2019

(54) APPARATUS AND METHOD FOR TIME-RESOLVED CAPTURE OF PULSED ELECTROMAGNETIC RADIO FREQUENCY RADIATION

(71) Applicant: Fraunhofer-Gesellschaft zur Förderung der angewandten Forschung e.V., München (DE)

(72) Inventors: Georg VON FREYMANN, Kaiserslautern (DE); Joachim JONUSCHEIT, Grünstadt (DE); Jens KLIER, Kaiserslautern (DE); Daniel MOLTER, Kaiserslautern (DE)

(73) Assignee: Fraunhofer-Gesellschaft zur Förderung der angewandten Forschung e.V., München (DE)

(21) Appl. No.: 16/336,933

(22) PCT Filed: Sep. 28, 2017
(86) PCT No.: PCT/EP2017/074580

§ 371 Date: Mar. 27, 2019

(30) Foreign Application Priority Data
Oct. 5, 2016 (DE) 10 2016 118 905.7

(51) Int. Cl. G01S 13/86; G01S 7/285; G01N 21/84; G01N 21/3586

(52) U.S. Cl. CPC G01S 13/86; G01S 7/285; G01N 2021/8438; G01N 21/3586; G01N 21/8422

(57) ABSTRACT

An apparatus for time-resolved capture of pulsed electromagnetic radio frequency radiation includes a generator being so adapted that in operation of the apparatus the generator produces pulses of the electromagnetic radio frequency radiation, a detector being so adapted that in operation of the apparatus the detector captures the field strength of the pulses reflected by a sample as a function of time, and a distance measurement system and an evaluation device connected to the detector and the distance measurement system. The distance measurement system is so adapted that in operation of the apparatus the distance measurement system captures a change in a distance between the generator and the sample and/or between the sample and the detector as a function of time. The evaluation device is so adapted that the evaluation device calculates a corrected function of the field strength over time from the captured function of the field strength over time and the detected function of the change in distance over time.

The invention concerns an apparatus for time-resolved capture of pulsed electromagnetic radio frequency radiation comprising a generator, wherein the generator is so adapted that in operation of the apparatus the generator produces pulses of electromagnetic radio frequency radiation, and a detector, wherein the detector is so adapted and arranged that in operation of the apparatus the detector captures the field strength or the intensity of the pulses reflected by a sample as a function of time.

The present invention further concerns a method for time-resolved capture of pulsed electromagnetic radio frequency radiation comprising the steps: producing pulses of electromagnetic radio frequency radiation with a generator, irradiating a sample with the pulses and capturing the field strength of the pulses reflected by the sample as a function of time with a detector.

Terahertz time domain spectrometers have long been used as excitation-retrieval measurement methods. A generated electromagnetic pulse in the terahertz frequency range, after passing through or reflection at a sample, is sampled in a detector by means of an optical pulse. In that case use is made of the fact that the optical pulse for sampling is markedly shorter in time than the pulse of the electromagnetic radiation in the terahertz frequency range. The electrical or magnetic field of the electromagnetic terahertz pulses is captured in time-resolved relationship by means of that measurement method. Using the function detected in that way in respect of the field strength in relation to time it is possible in particular by Fourier transformation to calculate frequency domain data but also it is possible to obtain information for example about layer thicknesses of a multi-layer sample.

That sampling measurement method provides usable measurement results as long as the time shift between the sampling optical pulse and the terahertz pulse is well defined by the measurement equipment and is not subject to any disturbances. If the time shift between the sampling optical pulses and the terahertz pulses changes due to mechanical disturbing influences during the sampling operation that method provides a distorted function of the field strength of the terahertz pulse in relation to time, the spectrum of the pulse is falsified and the measurement becomes unusable. Particularly in industrial environments and in robot-aided measurements however mechanical vibrations are scarcely avoidable, which leads to high levels of demand in terms of mechanical stability and possibly mechanical decoupling of the measurement system.

An approach for reducing the influence of mechanical disturbances involves increasing the measurement rate for each sampling operation for a pulse. The disturbance which occurs within a measurement operation considered in relative terms is reduced, the higher the measurement rate. However the maximum possible sampling or measurement rate for a terahertz time domain spectrometer is limited by the delay devices used. In addition increasing the measurement rate does not afford a fundamental way of resolving the problem, but only mitigates it in such a way that the disturbances are transformed into a lower frequency range.

Therefore the object of the present invention is to provide an apparatus and a method for time-resolved capture of pulsed electromagnetic high frequency radiation which reduce the influence due to mechanical disturbances on the measurement procedure.

At least one of the above-mentioned objects is attained by an apparatus for time-resolved capture of pulsed electromagnetic radio frequency radiation comprising a generator, wherein the generator is so adapted that in operation of the apparatus the generator produces pulses of electromagnetic radio frequency radiation, and a detector, wherein the detector is so adapted and arranged that in operation of the apparatus the detector captures the field strength of the pulses reflected by a sample as a function of time, wherein the apparatus further has a distance measurement system and an evaluation device connected to the detector and the distance measurement system, wherein the distance measurement system is so adapted and arranged that in operation of the apparatus the distance measurement system captures a change in the distance between the generator and the sample and/or between the sample and the detector as a function of time, and wherein the evaluation device is so adapted that the evaluation device calculates a corrected function of the field strength over time from the captured function of the field strength over time and the detected function of the change in distance over time.

What is significant for the present invention is that, independently of the generator and the detector for the pulses of the electromagnetic radio frequency radiation, that is to say in particular independently of the terahertz time domain spectrometer, changes in the distance between the generator and the sample and/or between the sample and the detector are detected as a function of time.

In that way the time base for the detected field strength of the pulses of the radio frequency radiation can be so corrected that it is dependent only on the time base which is predetermined by the apparatus. For that purpose the generator and the detector for the radio frequency radiation on the one hand and the distance measurement system on the other hand must be measurement systems which are independent and separate from each other.

In an embodiment of the invention the distance measurement system is an interferometer or a radar system.

In an embodiment an optical interferometer as a distance measurement system in accordance with the present invention has an accuracy in the region of 10 μm or better. In an embodiment the distance measurement system has a sampling rate of 0.5 MHz or more.

In an embodiment of the invention there is no need to determine the absolute distance between the generator and the sample and/or between the sample and the detector. Rather, what is involved is capturing changes in that distance.

Therefore in an embodiment of the invention in which the operation of determining the change in the distance is effected by means of an interferometer or a radar system it is not necessary to determine the absolute distance.

In an embodiment of the invention the frequency of the electromagnetic radio frequency radiation is in a frequency range of 1 GHz to 30 THz, preferably 100 GHz to 5 THz. That frequency range in accordance with the present application is referred to as a terahertz frequency range.

It will be appreciated that in that case the pulses of the electromagnetic radio frequency radiation are not mono-frequent but have a finite spectral bandwidth in dependence on the pulse duration.

While it is in principle possible to capture the electrical or magnetic field strength in time-resolved relationship with a detector for the pulses of the electromagnetic radio frequency radiation it will be desirable for most embodiments of the invention to capture the field strength of the electrical field.

In an embodiment of the invention the apparatus includes a time domain spectrometer, wherein the generator for the pulses of the electromagnetic radio frequency radiation and the detector for the pulses of the electromagnetic radio frequency radiation are constituent parts of that time domain spectrometer. In addition the time domain spectrometer includes a short pulse laser source which is so adapted that in operation of the apparatus it generates pulse-form optical electromagnetic radiation. Those short optical pulses then serve to drive the generator and to switch the detector.

Such generators and detectors for electromagnetic radiation in the terahertz frequency range, which are driven by or switched by electromagnetic pulses, are in particular non-linear optical crystals, so-called photoconductive or photoconducting switches based on semiconductor components and spintronic generators and detectors based on a multiplicity of metallic layers.

When using a photoconductive switch, possibly in combination with a respective antenna connected thereto, the impingement of a short electromagnetic pulse on the photoconductive switch with a suitable electrical biasing of the switch causes a short-term flow of current in the component and thus the emission of electromagnetic radio frequency radiation. In comparison the electromagnetic pulse on the detector side serves to briefly switch the detector by means of the photoconductive switch and thus render measurable the electrical field of the electromagnetic radio frequency radiation impinging on the detector at the same time.

If a current is measured at the feed lines of the photoconductive switch of the detector the field of the electromagnetic terahertz radiation which impinges on the radio frequency component can be captured in time-resolved fashion. The electrical field of the electromagnetic terahertz radiation impinging on the detector in that case drives charge carriers in the longitudinal direction by way of the switch. A flow of current is possible only when the photoconductive switch is closed at the same time, that is to say the switch is irradiated with the first electromagnetic radiation.

If an electromagnetic pulse used for switching or gating the photoconductive switch of the detector is short in relation to the time configuration of the electrical field of the pulse received by the detector in the terahertz frequency range then the electrical field of the terahertz signal can be measured or sampled in time-resolved relationship.

For that purpose a time shift between the terahertz pulses impinging on the detector and the electromagnetic pulses used for switching the detector is introduced and varied during the measurement procedure.

It will be appreciated that in an embodiment with a photoconductive switch as the detector the terahertz time domain spectrometer can have a suitable current or voltage amplifier which on the one hand is connected to the detector for detecting the currents across the switch of the detector and on the other hand to the evaluation device.

In an embodiment the apparatus has a beam splitting device which is so adapted and arranged that in operation of the apparatus it passes a first part of the optical pulses on to the generator and a second part of the optical pulses on to the detector. In an embodiment such a beam splitting device is a beam splitter, for example a fibre fused coupler. In an embodiment such a beam splitting device is implemented by a laser source which generates the optical pulses for generator and detector in such a way that they are already provided in spatially separate beam paths.

In addition in an embodiment the apparatus has a delay device which is so adapted that in operation of the apparatus a time delay between impingement of the radio frequency radiation and the optical pulses on the detector is adjustably variable with the delay device. In that case the delay device is further connected to the evaluation device, wherein the evaluation device is so adapted that in operation of the apparatus it controls the delay device and thus the time delay between the radio frequency pulse and the optical pulse on the detector.

In this embodiment the delay device provides the time base for the captured function of the field strength in relation to time. That time base however does not require any correction only when the actual delay between the electromagnetic radio frequency radiation and the optical radiation on the detector is not subject to any other influences than the time variation which is predetermined by the delay device. If however for example due to mechanical vibration the distance between the generator and the sample and/or between the sample and the detector changes then the time base predetermined by the delay device is falsified.

The present invention now makes it possible to correct that time base by the distance measurement system detecting a change in distance between the generator and the sample and/or between the sample and the detector as a function of time. Then, in the evaluation device, a corrected function of field strength in respect of time is calculated from the detected function of the field strength in respect of time and the detected function of the change in the distance in respect of time.

In an embodiment of the invention the evaluation device is a suitably programmed computer or microprocessor having the necessary interfaces. In an embodiment the interfaces serve to capture the field strength of the radio frequency radiation, to capture the change in the distance between the generator and the sample and/or between the sample and the detector as a function of time and to calculate the corrected function of the field strength in relation to time.

For that purpose in an embodiment the evaluation device is connected by way of a control line to the delay section, for example the encoder of a linear adjuster of the delay section. In addition in an embodiment the evaluation device is connected to the detector for the radio frequency radiation. In an embodiment the evaluation device is connected to a detector of the distance measurement system in order to be able to record and evaluate the function of a change in the distance between the generator and the sample and/or between the sample and the detector as a function of time.

In an embodiment of the invention the evaluation device is so adapted that for calculating the corrected function of the field strength in relation to time the detected field strength of a pulse is transferred at each time t to a time t′ which corresponds to that time at which the field strength would have been captured if the distance between the generator and the sample and/or between the sample and the generator would not have changed during sampling of the pulse.

At least one of the above-mentioned objects is also attained by a method for time-resolved capture of pulsed electromagnetic radio frequency radiation comprising the steps: producing pulses of electromagnetic radio frequency radiation with a generator, irradiating a sample with the pulses, and capturing the field strength of the pulses reflected by the sample as a function of time with a detector, capturing a change in a distance between the generator and the sample or between the sample and the detector as a function of time with a distance measurement system, and calculating a corrected function of the field strength over time from the captured function of the field strength over time and the function of the change in distance over time.

Insofar as aspects of the invention have been described hereinbefore in relation to the apparatus for time-resolved capture of pulsed electromagnetic radio frequency radiation they also apply to the corresponding method. Insofar as the method is carried out with an apparatus for time-resolved capture of pulsed electromagnetic radio frequency radiation in accordance with this invention it has the corresponding devices for that purpose. In particular embodiments of the apparatus are suitable for carrying out the method.

In an embodiment of the method according to the invention the corrected function of the field strength in respect of time is calculated by the captured field strength of a pulse being transferred at each time t to a time t′ which corresponds to that time at which the field strength would have been captured if the distance between the generator and the sample or between the sample and the detector would not have changed during the duration of the pulse.

If at a time t or around same no change in the distance between the generator and the sample and/or between the sample and the detector is captured by means of the distance measurement system the field strength remains associated with that time t which is thus predetermined exclusively by the time base predetermined by the delay device. If however a change in the distance is detected at the time t then the field strength is shifted or transferred from the time t predetermined by the delay device to a time t′ which corresponds to the time shift between optical pulse and radio frequency pulse on the detector if no change in the distance between the generator and the sample and/or between the sample and the detector would have occurred.

The method according to the invention is particularly suitable for determining layer thicknesses of a plurality of N mutually superposed layers, like for example layers of paint. In an embodiment of the invention therefore the sample has a plurality of N mutually superposed layers Sᵢ each of a layer thickness dᵢ, wherein i is equal to 1, 2, 3 . . . , N, wherein the layer thicknesses dᵢ of all N layers are determined from the corrected function of the field strength in relation to time.

For determining the layer thicknesses the pulse response of the sample, that is to say the radio frequency radiation which is reflected by the sample and interacted with the sample is fitted with a model.

For that purpose in an embodiment of the invention the operation of determining the layer thicknesses dᵢ includes the steps:

a) selecting a layer thickness dᵢ, an absorption index kᵢ and a refractive index nᵢ for each layer Sᵢ, with i=1, 2, 3, . . . , N,

b) calculating a time-dependent electrical field E_{M}(t) for the electromagnetic radio frequency radiation reflected by the sample by means of a model, wherein the model respectively takes account of a time-dependent electrical field Eⱼ(t) with j=0, 1, 2, 3, . . . , N according to the number of N+1 interfaces between a measurement environment and the sample and between the individual layers, wherein the electrical fields Eⱼ(t) are added in dependence on the layer thicknesses dᵢ, the absorption index kᵢ and the refractive index nᵢ to the time-dependent electrical field E_{M}(t),

c) comparing the calculated time-dependent electrical field E_{M}(t) to the corrected function of the field strength over time, wherein

d) when a deviation Q between the calculated field strength E_{M}(t) and the corrected function of the field strength E_{P}(t) is greater than a predetermined tolerance T at least the layer thicknesses dᵢ are varied for so long and steps b) to d) are repeated until the deviation Q is smaller than the tolerance T, and

e) providing the layer thicknesses dᵢ as the result of the layer thickness determining operation.

In that respect in an embodiment in step d) the absorption index kᵢ and the refractive index nᵢ are also varied to determine the layer thickness.

In an embodiment of the invention the number of iteration steps is reduced by assumptions being made about dispersion, that is to say the frequency dependency of the absorption index kᵢ and refractive index nᵢ within the frequency bandwidth of the electromagnetic radio frequency radiation used, with those assumptions being incorporated into the calculation in step b).

In an embodiment the electromagnetic radio frequency radiation produced in the generator has a predetermined frequency bandwidth and it is assumed that no dispersion occurs within the predetermined frequency bandwidth of the radio frequency radiation, that is to say the absorption indices kᵢ and refractive indices nᵢ are assumed to be constant in the calculation step b) over the frequency bandwidth of the electromagnetic radio frequency radiation used.

In an alternative embodiment thereto the electromagnetic radio frequency radiation produced in the generator has a predetermined frequency bandwidth and for the frequency dependency of the absorption indices kᵢ and the refractive indices nᵢ over the predetermined frequency bandwidth a simple function describing the dependency, for example the Drude-Lorentz model, is assumed in the calculation step b).

In a further alternative embodiment the electromagnetic radio frequency radiation produced in the generator has a predetermined frequency bandwidth and the frequency dependencies of the refractive indices n and the absorption indices kᵢ over the predetermined frequency bandwidth is detected separately for all layers previously in calibration measurements and the measurement values obtained in that way form the basis for calculation in step b).

In an embodiment of the invention capture of the change in the distance between the generator and the sample or between the sample and the detector as a function of time is effected with a measurement rate of 100 kHz or more, preferably 150 kHz or more and particularly preferably 200 kHz or more.

Further advantages, features and possible uses of the present invention will be apparent from the description hereinafter of an embodiment and the accompanying Figures.

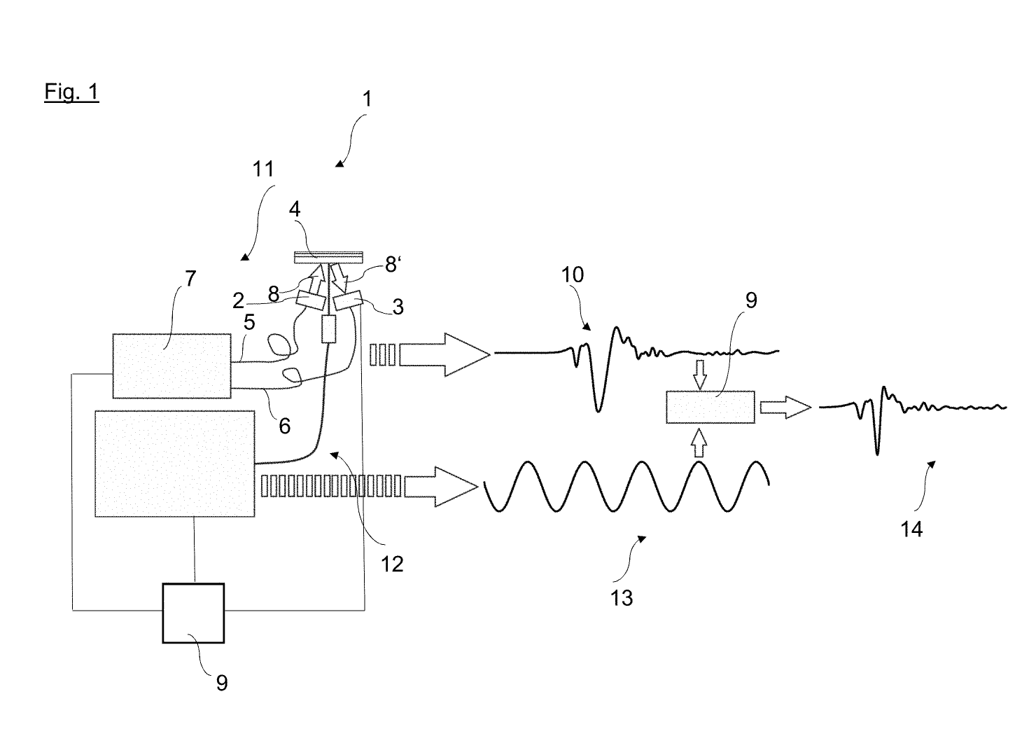

FIG. 1 is a diagrammatic view of the apparatus according to the invention for time-resolved capture of pulsed electromagnetic radio frequency radiation,

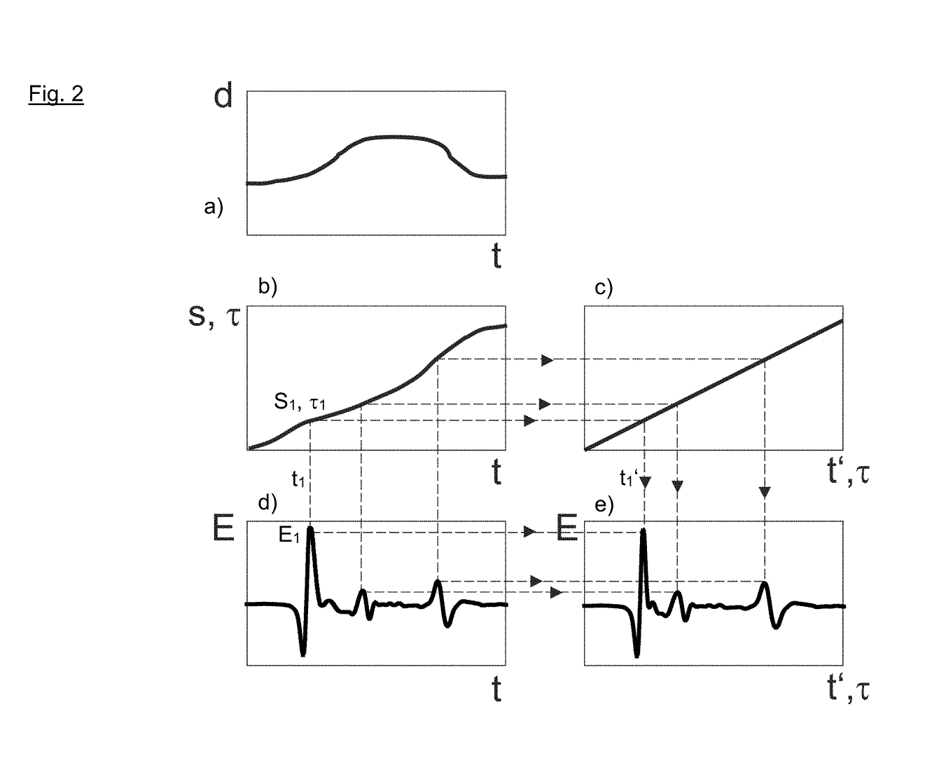

FIG. 2 is a diagrammatic view of the method according to the invention for time-resolved capture of pulsed electromagnetic radio frequency radiation with the apparatus of FIG. 1,

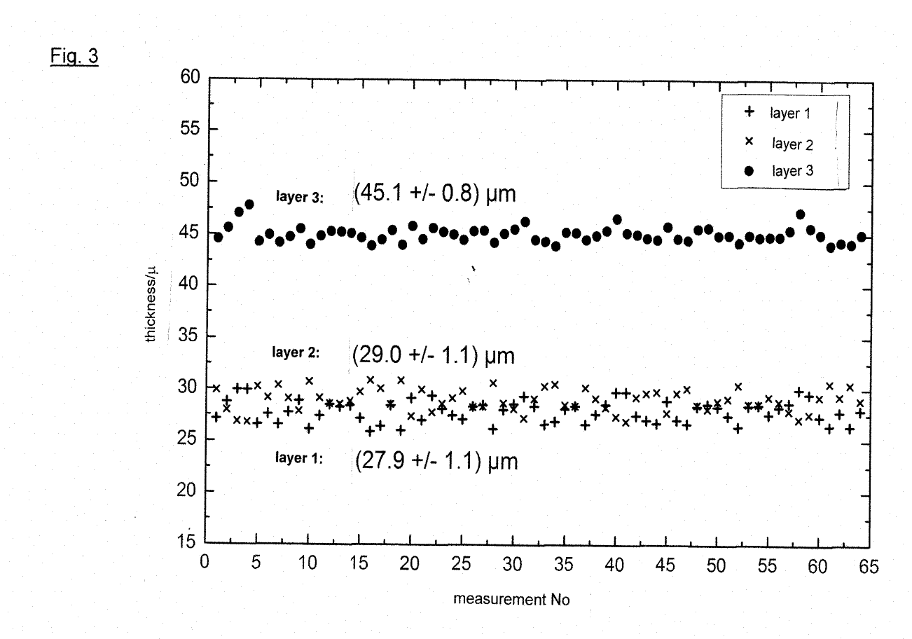

FIG. 3 shows a layer thickness measurement on a sample with 3 layers without the distance correction according to the invention, and

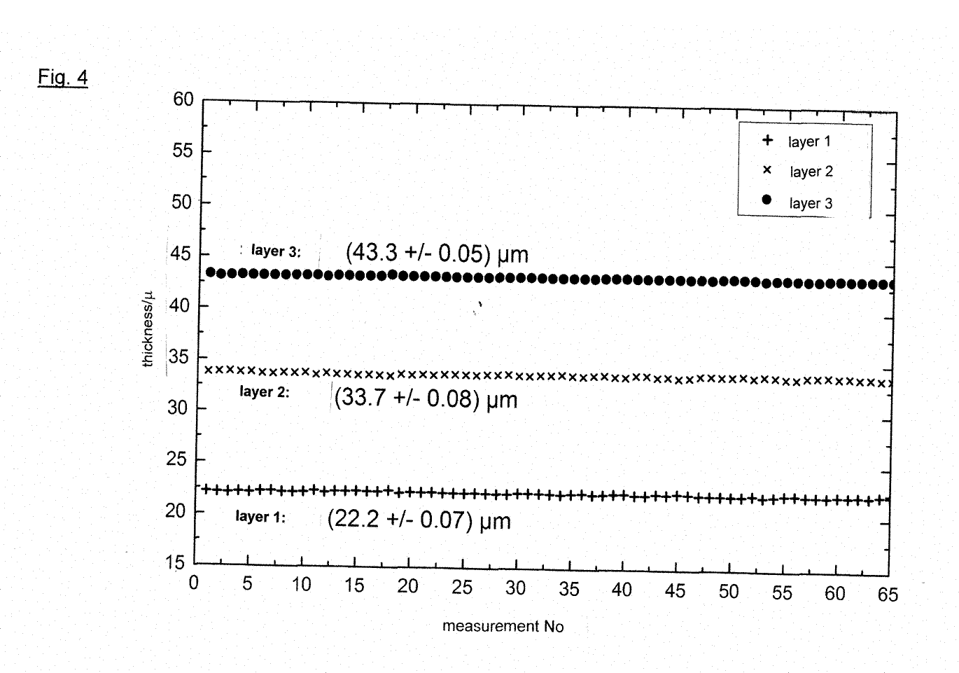

FIG. 4 shows the measurement result of the layer thickness determining operation in respect of the sample with 3 layers as shown in FIG. 3 but with the distance correction according to the invention.

In the Figures identical elements are identified by identical references.

FIG. 1 shows a terahertz time domain spectrometer 11 as part of the apparatus 1 according to the invention for time-resolved capture of pulsed electromagnetic radio frequency radiation in accordance with the invention.

The time domain spectrometer 11 includes a generator 2 for producing the pulsed electromagnetic radio frequency radiation 8 and a detector 3 for detecting the electrical field strength of the pulses reflected by a sample 4 as a function of time.

The sample 4 is a three-layer paint sample, wherein the terahertz time domain spectrometer 11 serves to determine the thickness of all three layers of the paint sample 4. Both the generator 2 and also the detector 3 are connected by way of optical glass fibres 5, 6 to a femtosecond laser as a short pulse laser source in accordance with the present invention. The femtosecond laser is part of an arrangement which is denoted by reference 7 in FIG. 1 and which is only diagrammatically illustrated. The short optical pulses generated by the femtosecond laser are divided to two beam paths by means of a fibre fused coupler also provided in the arrangement 7, so that a part of the pulses is passed to the generator 2 by way of the glass fibre 5 and another part of the pulses is passed to the detector 3 by way of the glass fibre 6.

In addition provided in the arrangement 7 is a delay section in the form of a delay device in accordance with the invention comprising an adjustably variable optical path. That serves to delay the optical pulses reaching the generator 2 and the pulses reaching the generator 3 relative to each other in order in that way to permit sampling and time-resolved capture of the electrical field of the terahertz radiation 8′ which is generated by the generator 2 and interacted with the sample in the detector 3.

Both the generator 2 and also the detector 3 involve photoconductive switches which are incorporated into antennae for the terahertz radiation. While the first switch/antenna combination 2 is used for producing the terahertz radiation 8 the second switch/antenna combination 3 is used for time-resolved capture of the terahertz radiation 8′ reflected by a sample 4.

Upon short-term closure of the photoconductive switch of the generator 2 by means of the ultrashort optical pulses which are passed by the glass fibre 5 to the switch the latter is rendered electrically conductive for a short time so that, with a suitable bias, a current pulse flows through the switch and leads to the emission of an electromagnetic radio frequency pulse. In the photoconductive switch which forms a part of the detector 3 the electrical field of an impinging terahertz pulse then leads to driving of free charge carriers by way of the photoconductive switch when same is just illuminated by means of an optical pulse issuing from the glass fibre 6. Then it is possible by way of the photoconductive switch of the detector 3 to measure a current which is proportional to the instantaneous electrical field of the terahertz pulse. As the optical pulse for switching the detector 3 is unequally shorter in time than the time extent of the oscillation of the electrical field of the terahertz pulse the terahertz pulse can be sampled in time-resolved relationship by a delay of the optical pulse in relation to the terahertz pulse on the photoconductive switch of the detector 3.

For that purpose the detector 3 is connected to an evaluation device 9 by way of a measurement amplifier. That evaluation device 9 also provides for controlling the delay section in the arrangement 7. The currently prevailing position of the delay section then predetermines the time base for the detected function of the electrical field in relation to time.

The right-hand half of FIG. 1 by way of example illustrates the time dependency of the electrical field of a terahertz pulse reflected by the sample 4. The representation denoted by reference 10 shows the electrical field strength plotted in relation to time.

The signal configuration obtained in that way is however the actual configuration of the electrical field with time only when the distance between the sample 4 and the detector 3 does not change at the same time. Otherwise the time base is falsified by changes to that distance as those changes in distance in respect of the time base are not taken into consideration in the signal 10. The signal 10 is then distorted.

According to the invention now the time base generated by the delay section in the arrangement 7 is corrected by means of the fluctuations in the distance between the sample and the detector 3. For that purpose, besides the terahertz time domain spectrometer 11, the apparatus 1 according to the invention has a distance measurement system in the form of an optical interferometer 12. The interferometer 12 serves to detect changes in distance between the sample 4 and the detector 3 with the same sampling rate with which the electrical field is also detected by means of the terahertz time domain spectrometer 11.

The change in distance of the sample 4 from the generator 2 and the detector 3 is plotted as a function of time in the right-hand side of FIG. 1 and identified by reference 13. For diagrammatic consideration in FIG. 1 it is assumed that the sample 4 performs a vibratory movement about a starting point so that the distance between the sample 4 and the detector 3 changes substantially sinusoidally.

That function of the detected change in distance in relation to time is also processed in the evaluation device 9 and, as also diagrammatically indicated in the right-hand half of FIG. 1, used for correction of the time base of the detected function 10 of the field strength in relation to time. As a result that then gives a corrected function 14 for the field strength in relation to time.

Reference will now be made to the graphs in FIG. 2 to set forth once again in detail how the evaluation device 9 calculates a corrected function 14 for the field strength in relation to time from the detected function 10 of the field strength in relation to time and the detected function 13 of the change in distance in respect of time.

FIG. 2c) shows a view of the travel difference S predetermined by the delay section between the terahertz pulse and the optical pulse on the detector 3 in relation to time t′. In that case the difference S introduced by the delay section corresponds to a time delay τ which electromagnetic radiation passing through the delay section experiences in relation to radiation in a reference path. That time delay τ is the time base which is predetermined by the delay section for the measurement procedure.

FIG. 2c) assumes that the rate of change in the travel difference in relation to time is constant. However the difference S between the terahertz pulse and the optical pulse on the detector 3 is additionally subjected to fluctuations by virtue of changes in the distance d between the sample 4 and the detector 3. FIG. 2a) shows the distance d between the sample 4 and the detector 3 plotted in relation to time t. The fluctuations in the distance can be clearly seen. That change in the distance d with time t means that the actual difference S in relation to the elapsed time t, unlike the situation shown in FIG. 2c), is not a linear function but is of a configuration as is shown by way of example in FIG. 2b).

In order now to correct measurement of the electrical field of the terahertz radiation 8 in relation to time in FIG. 2d) a first measurement point for example is considered at the time t₁. At that time t₁ the difference in travel length between the terahertz pulse and the optical pulse on the detector 3 is S₁ corresponding to a delay τ₁. That travel length difference S₁ however corresponds to a time t′₁ in the case of an idealised time base which is only predetermined by the delay section. Accordingly the measurement value E₁ of the electrical field E in the graph in FIG. 2d) is shifted from the time t₁ to the time t′₁. If that transformation is implemented for all measurement points of the electrical field E in relation to time t from the raw data in FIG. 2d) that gives the corrected function, cleared of the fluctuations in distance of FIG. 2a), of the electrical field E in relation to time t′ in FIG. 2e).

In the embodiment being discussed here the apparatus is used for determining the layer thicknesses of the three mutually superposed layers of the sample 4. Upon irradiation of the sample 4 with the pulses of the terahertz radiation with a predetermined frequency bandwidth the impinging radiation is partially reflected at each interface, that is to say between the measurement environment and the sample and between two mutually adjoining layers. The time-dependent electrical fields of those partial reflections are superimposed in relation to the time-dependent electrical field of the sample, which is detected in time-resolved manner upon measurement with the detector 3. Upon precise consideration the electrical field E_{P}(t) of the sample additionally also includes multiple reflections which occur due to repeated reflections of the radio frequency radiation at the interfaces. The time sequence of the partial reflections and the phases thereof depend on the material parameters of the layers.

To determine all three layer thicknesses of the sample 4 with a plurality of N=3 mutually superposed layers Sᵢ with i=1, 2, 3, the following steps are carried out: each of those layers has a refractive index nᵢ, an absorption index kᵢ and a layer thickness dᵢ which influence the reflection and transmission properties of the layers for the electromagnetic radio frequency radiation used. In a step a) a layer thickness dᵢ, a refractive index nᵢ and an absorption index kᵢ are selected as starting values for each layer Sᵢ. In a subsequent step b) a time-dependent electrical field E_{M}(t) is calculated by means of a model for the electromagnetic radio frequency radiation reflected by or transmitted by the sample. The model includes a respective time-dependent electrical field Eⱼ(t), with j=0, 1, 2, 3 corresponding to a number of N+1 interfaces between the measurement environment and the sample and between the individual layers, wherein the electrical fields Eⱼ(t) are added to the time-dependent electrical field E_{M}(t) of the model in dependence on the layer thicknesses dᵢ, the refractive indices nᵢ and the absorption indices kᵢ. In that case the model is based on the assumption that the refractive index nᵢ and the absorption index kᵢ of each layer Sᵢ are constant over the frequency bandwidth of the radio frequency radiation used, that is to say independent of the frequency of the radio frequency radiation. Then in a step c) the calculated electrical field Eₘ(t) of the model is compared to the detected electrical field E_{P}(t) of the sample, wherein in step d) if a deviation Q between the calculated electrical field E_{M}(t) and the detected electrical field E_{P}(t) is greater than a predetermined tolerance T the layer thicknesses dᵢ, the refractive indices nᵢ and the absorption indices kᵢ are varied and the steps b) to d) are repeated, until the deviation Q is less than the tolerance T.

If the deviation Q is smaller than the tolerance T then in a step e) the layer thicknesses dᵢ are provided as the result of the layer thickness determining procedure.

FIG. 3 shows measurement results of a corresponding procedure for determining the three layer thicknesses of the sample 4, the correction being done away with in the evaluation device 9. In other words the layer thicknesses were determined on the basis of the detected function of the field strength in relation to time. FIG. 3 plots the result of the layer thickness measurement for the three layers of the sample 4, identified as layer 1 to layer 3, in relation to the order number of the corresponding measurement. It will be clearly seen that the individual measurement values have a spread of up to 2.5 μm around the mean value of the thickness.

In comparison FIG. 4 shows the measurement results of the procedure for determining the layer thicknesses of the three layers of the same sample 4. Once again the result of layer thickness measurement for the three layers of the sample 4, identified as layer 1 to layer 3, is plotted against the order number of the corresponding measurement. In these measurements layer thickness determining is effected however with the correction switched on. In other words the layer thicknesses were determined with the corrected function of the field strength in relation to time. It is worth noting that not only the spread of the individual measurement values around a mean value is considerably reduced in comparison with the measurements without correction for each of the layers, but also that the absolute values of the layer thicknesses have experienced a considerable correction. It is in that respect that the considerable influence of distortion of the time base of the detected function of the electrical field is shown in relation to time by fluctuations in the distance of the sample 4 from the detector 3.

For the purposes of the original disclosure it is pointed out that all features as can be seen by a man skilled in the art from the present description, the drawings and the claims, even if they are described in specific terms only in connection with certain other features, can be combined both individually and also in any combinations with others of the features or groups of features disclosed here insofar as that has not been expressly excluded or technical aspects make such combinations impossible or meaningless. A comprehensive explicit representation of all conceivable combinations of features and emphasis of the independence of the individual features from each other is dispensed with here only for the sake of brevity and readability of the description.

While the invention has been illustrated and described in detail in the drawings and the preceding description that illustration and description is only by way of example and is not deemed to be a limitation on the scope of protection as defined by the claims. The invention is not limited to the disclosed embodiments.

Modifications in the disclosed embodiments are apparent to the man skilled in the art from the drawings, the description and the accompanying claims. In the claims the word ‘have’ does not exclude other elements or steps and the indefinite article ‘a’ does not exclude a plurality. The mere fact that certain features are claimed in different claims does not exclude the combination thereof. References in the claims are not deemed to be a limitation on the scope of protection.

### LIST OF REFERENCES

1 apparatus for time-resolved capture of pulsed electromagnetic radio frequency radiation
2 generator
3 detector
4 sample
5,6 glass fibre
7 arrangement with short pulse laser system, delay section and beam splitter
8 terahertz radiation generated by the generator 2
8′ terahertz radiation interacted with the sample 4
9 evaluation device
10 detected electrical field strength of the terahertz radiation as a function of time
11 terahertz time domain spectrometer
12 optical interferometer
13 distance as a function of time
14 corrected electrical field strength of the terahertz radiation as a function of time

1: An apparatus for time-resolved capture of pulsed electromagnetic radio frequency radiation comprising
a generator, wherein the generator is so adapted that in operation of the apparatus the generator produces pulses of the electromagnetic radio frequency radiation,
a detector, wherein the detector is so adapted and arranged that in operation of the apparatus the detector captures the field strength of the pulses reflected by a sample as a function of time,
a distance measurement system, and
an evaluation device connected to the detector and the distance measurement system,
wherein the distance measurement system is so adapted and arranged that in operation of the apparatus the distance measurement system captures a change in a distance between the generator and the sample and/or between the sample and the detector as a function of time, and
wherein the evaluation device is so adapted that the evaluation device calculates a corrected function of the field strength over time from the captured function of the field strength over time and the detected function of the change in distance over time.

2: The apparatus according to claim 1 wherein the distance measurement system is an interferometer or a radar system.

3: The apparatus according to claim 1, further comprising a time domain spectrometer comprising:
a short pulse laser source which is so adapted that in operation of the apparatus it produces optical electromagnetic radiation in pulse form,
the generator for the pulses of the electromagnetic radio frequency radiation,
the detector for the pulses of the electromagnetic radio frequency radiation,
a beam splitting device which is so adapted and arranged that in operation of the apparatus it passes a first part of the optical radiation on to the generator and a second part of the optical radiation on to the detector, and
a delay device which is so adapted that in operation of the apparatus a time delay between impingement of the pulses of the electromagnetic radio frequency radiation and the pulses of the optical electromagnetic radiation on the detector is adjustably variable with the delay device,
wherein the delay device is connected to the evaluation device, and
wherein the evaluation device is so adapted that in operation of the apparatus it controls the delay device and the time delay.

4: A method for time-resolved capture of pulsed electromagnetic radio frequency radiation comprising the steps:
producing pulses of electromagnetic radio frequency radiation with a generator,
irradiating a sample with the pulses of the electromagnetic radio frequency radiation, and
capturing the field strength of the pulses reflected by the sample as a function of time with a detector,
capturing a change in a distance between the generator and the sample or between the sample and the detector as a function of time with a distance measurement system, and
calculating a corrected function of the field strength over time from the captured function of the field strength over time and the function of the change in distance over time.

5: The method according to claim 4, wherein the corrected function of the field strength is calculated by the captured field strength of a pulse being transferred at each time t to a time t′ which corresponds to that time at which the field strength would have been captured if the distance between the generator and the sample or between the sample and the detector would not have changed during the duration of the pulse.

6: The method according to claim 4, wherein the sample has a plurality of N mutually superposed layers Sᵢ each of a layer thickness dᵢ, wherein i=1, 2, 3, . . . , N and wherein the layer thicknesses dᵢ of all N layers are determined from the corrected function of the field strength over time.

7: The method according to claim 6, wherein the operation of determining the layer thicknesses dᵢ includes the steps:
a) selecting a layer thickness dᵢ, an absorption index kᵢ and a refractive index nᵢ for each layer Sᵢ, with i=1, 2, 3, . . . , N,
b) calculating a time-dependent electrical field E_{M}(t) for the electromagnetic radio frequency radiation reflected by the sample by means of a model, wherein the model respectively takes account of a time-dependent electrical field Eⱼ(t) with j=0, 1, 2, 3, . . . , N according to the number of N+1 interfaces between a measurement environment and the sample and between the individual layers, wherein the electrical fields Eⱼ(t) are added in dependence on the layer thicknesses dᵢ, the absorption indices kᵢ and the refractive indices nᵢ to the time-dependent electrical field E_{M}(t),
c) comparing the calculated time-dependent electrical field E_{M}(t) to the corrected function of the electrical field over time, wherein
d) when a deviation Q between the calculated electrical field E_{M}(t) and the captured electrical field E_{P}(t) is greater than a predetermined tolerance T the layer thicknesses dᵢ, the refractive indices nᵢ and the absorption indices kᵢ are varied for so long and steps b) to d) are repeated until the deviation Q is smaller than the tolerance T, and
e) providing the layer thicknesses dᵢ as the result of the layer thickness determining operation.

8: The method according to claim 7, wherein the electromagnetic radio frequency radiation has a predetermined frequency bandwidth and in step b) the absorption indices kᵢ is assumed to be constant over the frequency bandwidth of the electromagnetic radio frequency radiation used and the refractive indices nᵢ is assumed to be constant over the frequency bandwidth of the electromagnetic radio frequency radiation used.

9: The method according to claim 7, wherein the electromagnetic radio frequency radiation has a predetermined frequency bandwidth and in step b) the absorption indices kᵢ are assumed to be changing over the frequency bandwidth of the electromagnetic radio frequency radiation used and the refractive indices nᵢ are assumed to be changing over the frequency bandwidth of the electromagnetic radio frequency radiation used, wherein the calculation in step b) is based on a function of the absorption indices kᵢ and the refractive indices nᵢ on the frequency.

10: The method according to claim 7, wherein the electromagnetic radio frequency radiation has a predetermined frequency bandwidth and the frequency dependencies of the absorption indices kᵢ and the refractive indices nᵢ are predetermined in advance in calibration measurements over the frequency bandwidth for each of the layers and the predetermined frequency dependencies form the basis for the calculation in step b).

11: The method according to claim 4, wherein capture of the change in the distance between the generator and the sample or between the sample and the detector as a function of time is effected with a measurement rate of 100 kHz or more.
